(19) United States
(12) Patent Application Publication
(10) Pub. No.: US 2020/0036034 A1
(43) Pub. Date: Jan. 30, 2020

(54) HIGH-CAPACITY POLYMER LITHIUM-ION BATTERY STRUCTURE

(71) Applicant: Michael Wang, Beijing (CN)

(72) Inventor: Michael Wang, Beijing (CN)

(21) Appl. No.: 16/043,465

(22) Filed: Jul. 24, 2018

(51) Int. Cl. H01M 10/0525; H01M 10/0583; H01M 2/26; H01M 2/18; H01M 2/06; H01M 4/02

(52) U.S. Cl. CPC H01M 10/0525; H01M 10/0583; H01M 2/263; H01M 2004/028; H01M 2/06; H01M 4/02; H01M 2004/027; H01M 2/18

(57) ABSTRACT

A high-capacity polymer lithium-ion battery structure is implemented by increasing a battery length and a battery width and reducing a battery thickness, to thereby manufacture a high-capacity battery. The internal structure of the battery is formed by stacking a positive electrode sheet, a negative electrode sheet, and a separator diaphragm having the same shape and size. Tabs of the positive electrode sheet and the negative electrode sheet are combined, copper sheets, aluminum sheets or nickel sheets are respectively soldered for leading, and three layers of aluminum-plastic composite films are thermally sealed. During use, parallel connections are reduced, and serial connections are needed to satisfy the requirements of current large electricity utilization products such as electric bicycles and electric cars. Improved safety, reliability, and reduced manufacturing costs are achieved by the battery design of this invention.

### TECHNICAL FIELD

The present invention relates to the field of clean energy devices, and, in particular, relates to a high-capacity polymer lithium-ion battery structure.

### BACKGROUND

In present times, conventional energy resources such as petroleum, coal, and natural gas are continuously mined, resources are getting close to exhaustion, and the ecological pressure is approaching the limit. Humans urgently need to develop renewable resources that are renewable and environmentally friendly and have high specific energy. A lithium-ion battery has advantages such as high specific energy, high conversion efficiency, environmental friendliness, a long cycle life, and low self-discharge, and is an optimal energy storage apparatus that has a wide application scope. However, at present, most lithium-ion batteries are only applied to electronics industries such as the communication industry and the IT industry.

The methods for producing and manufacturing the lithium-ion batteries all belong to a small battery process system with the battery capacity being less than 5 Ah. Theoretically, small batteries can be connected in parallel to form high-capacity batteries to satisfy electricity utilization requirements of large power apparatuses and energy storage systems such as various electric motorcycles, electric cars, and uninterruptible power supplies (UPS). Many companies develop the market of high-capacity battery application in this manner. However, in practice, single batteries need to be highly consistent to connect small batteries in parallel. If any battery in a parallel-connected battery pack encounters a problem, the performance of the entire battery pack will be affected. Moreover, it is necessary to add a battery management system to an application of lithium-ion batteries. Current battery management technologies only support management of serial connections. There is no electronic technology for managing batteries connected in parallel. From the perspective of technology and industrialization, solutions of parallel-connected small batteries can hardly satisfy current requirements of high-capacity batteries.

In current situations, high-capacity single batteries are packaged in rigid metal cases and in plastic cases. A rigid metal case structure has an advantage of desirable pressure resistance, so that battery expansion does not occur easily, but has disadvantages of a short cycle life and low safety. If a plastic case structure is used, a battery is thick and has poor heat dissipation and low stability. Moreover, batteries with the foregoing two structures are both liquid lithium-ion batteries. An electrolyte may flow freely in a case body and leak easily. Positive and negative electrodes may easily displace under the effects of heat and external forces during long-time use in the future, resulting in performance failures or safety accidents.

Therefore, it would be desirable to improve energy devices such as batteries to address these and other drawbacks in the known art.

### SUMMARY

To overcome the foregoing deficiencies, the objective of the present invention is to provide a high-capacity polymer lithium-ion battery structure.

In one embodiment, a positive electrode sheet, a separator diaphragm, a negative electrode sheet, a separator diaphragm, and a positive electrode sheet are sequentially stacked and thermally combined to form one battery unit. A plurality of battery units is connected in parallel. Tabs of the positive electrode sheets are connected in parallel and are then connected to a positive electrode of a battery housing. Tabs of the negative electrode sheet are connected in parallel and are then connected to a negative electrode of the battery housing. The tabs of the positive electrode sheets and the tabs of the negative electrode sheet are sealed in the battery housing. Alternatively, a positive electrode sheet, a separator diaphragm continuously folded to wrap N negative electrode sheets, and a positive electrode sheet form a battery unit group stack structure. Tabs of the two positive electrode sheets are connected in parallel and are then connected to the positive electrode of the battery housing. Tabs of the N negative electrode sheets are connected in parallel and are then connected to the negative electrode of the battery housing.

In one aspect, the positive electrode sheets and the negative electrode sheets have increasing sizes in length and width directions.

In another aspect, the separator diaphragm is cut into single or continuously folded square sheets whose sizes are greater than those of the positive electrode sheets and the negative electrode sheets.

In some embodiments, N is between 2 and 35.

In a further aspect, a battery cell capacity is between 50 Ah and 2000 Ah, a battery length is between 200 mm and 1000 mm, a battery width is between 200 mm and 1000 mm, and a battery thickness does not exceed 10 mm to 30 mm.

The advantages and technical effects achieved by the present invention are as follows. An entire battery electrode sheet group is located in a same electrolyte environment, so that an electrochemical system is stable and effective, and the battery performance is stable. A battery core is formed by stacking small positive electrode sheets and negative electrode sheets, so that an interfacial resistance between electrode sheets is small and the battery generates a small amount of heat. The electrode sheets are bonded by using a polymer technology and do not displace relative to each other under the effect of mechanical vibration, so that the battery performance is reliable and stable. In addition, the length of an electrode sheet used in a high-capacity battery is restricted within 1000 mm, to avoid a defect that electrode sheets in other high-capacity batteries are up to 10 meters long. The battery capacity of the structure of the present utility model is suitable for large-scale industrial production of high-capacity lithium-ion batteries, the process is simple, the working efficiency is high, batteries have desirable consistency, the performance is stable and reliable, and the safety is high.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrates one or more embodiments of the invention and, together with the general description given above and the detailed description given below, explains the one or more embodiments of the invention.

FIG. 1 is a schematic side view of a cell unit used with a battery in accordance with one embodiment of the invention.

FIG. 2 is a schematic front view of a continuously folded combination of positive and negative electrode sheets of a battery in accordance with another embodiment of the invention.

FIG. 3 a schematic diagram of a positive electrode sheet used in various embodiments of the invention.

FIG. 4 is a schematic diagram of a negative electrode sheet used in various embodiments of the invention.

FIG. 5 is a schematic diagram of a separator diaphragm used in various embodiments of the invention.

FIG. 6A is a schematic front view of the high-capacity lithium-ion battery in accordance with one embodiment of the invention.

FIG. 6B is a schematic side view of the high-capacity lithium-ion battery of FIG. 6A.

### DETAILED DESCRIPTION

Embodiments of the invention are illustrated below with reference to the accompanying drawings. The preferred embodiments described here are used only to describe and explain the present disclosure, but not to limit the present disclosure.

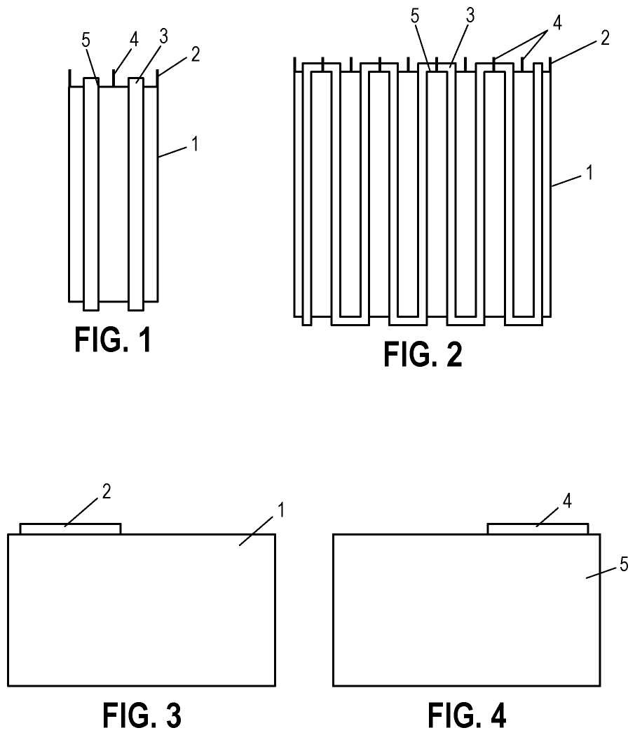

The present invention provides a high-capacity polymer lithium-ion battery structure, which is described below with reference to the accompanying drawings. As shown in FIG. 1, for example, a positive electrode sheet 1, a separator diaphragm 3, a negative electrode sheet 5, a separator diaphragm 3, and a positive electrode sheet 1 are sequentially stacked and thermally combined to form one cell unit. A plurality of cell units is connected in parallel. Tabs 2 of the positive electrode sheets 1 are connected in parallel and are then connected to a positive electrode 8 of a battery housing 6 (referring to FIGS. 6A and 6B). Tabs 4 of the negative electrode sheet 5 are connected in parallel and are then connected to a negative electrode of the battery housing 6. The tabs 2 of the positive electrode sheets 1 and the tabs 4 of the negative electrode sheet 5 are sealed in the battery housing, as shown in FIGS. 6A and 6B. Alternatively, a positive electrode sheet 1, a separator diaphragm 3 continuously folded to wrap N negative electrode sheets 5, and a positive electrode sheet 1 form a battery unit group stack structure. Tabs 2 of the two positive electrode sheets 1 are connected in parallel and are then connected to the positive electrode 8 of the battery housing 6. Tabs 4 of the N negative electrode sheets 5 are connected in parallel and are then connected to the negative electrode 7 of the battery housing 6.

The positive electrode sheets and the negative electrode sheets have increasing sizes in length and width directions.

The separator diaphragm is cut into single or continuously folded square sheets whose sizes are greater than those of the positive electrode sheets and the negative electrode sheets.

N is between 2 and 88 according to these embodiments.

A battery cell capacity is between 50 Ah and 2000 Ah, a battery length is between 200 mm and 1000 mm, a battery width is between 200 mm and 1000 mm, and a battery thickness does not exceed 10 mm to 30 mm.

### Example 1

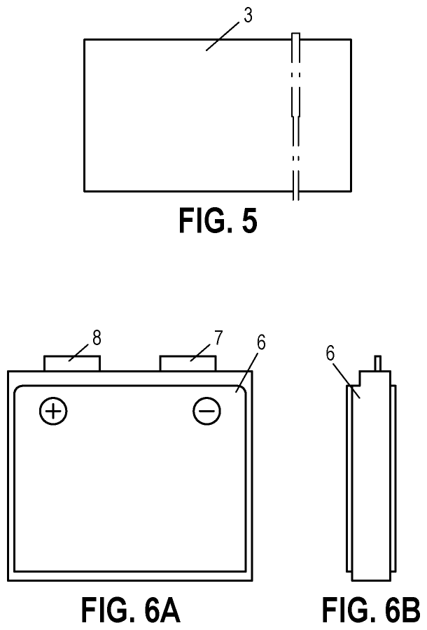

Through stirring and coating, a positive active material is applied on a single surface of an aluminum foil of a positive current collector, and the aluminum foil is cut into a shape as shown in FIG. 3. A negative active material is applied on both surfaces of a copper foil of a negative current collector, and the copper foil is cut into a shape as shown in FIG. 4. A separator diaphragm is cut into a square sheet, as shown in FIG. 5, whose size is greater than that of the positive electrode sheet and that of the negative electrode sheet. Two positive electrode sheets are used, where a battery length is between 200 mm and 1000 mm, a battery width is between 200 mm and 1000 mm, and a battery thickness does not exceed 10 mm to 30 mm. A separator diaphragm is used, where a battery length is between 200 mm and 1000 mm, a battery width is between 200 mm and 1000 mm, and a battery thickness does not exceed 10 mm to 30 mm. One negative electrode sheet is used, where a battery length is between 200 mm and 1000 mm, a battery width is between 200 mm and 1000 mm, and a battery thickness does not exceed 10 mm to 30 mm. Next, based on the structure in FIG. 1, the positive electrode sheet 1, the separator diaphragm 3, the negative electrode sheet 5, the separator diaphragm 3, and the positive electrode sheet 1 are sequentially stacked and thermally combined to form one battery unit. Unit batteries whose quantity is calculated based on an energy-to-volume ratio wh/L of the battery are then connected in parallel at tabs and are soldered to a lead tab whose thickness and width are suitable. An aluminum material is used for the positive electrode, and a copper material or a nickel material is used for the negative electrode. An aluminum-plastic composite packaging film is then used to perform thermal packaging.

After an electrolyte is filled, a high-capacity polymer lithium-ion battery is obtained. The structure of the battery as finalized by this example is shown in FIGS. 6A and 6B. Electrode sheet sizes in this example are used. 23 unit batteries are stacked. Aluminum tabs and copper tabs having a width of 280 mm and a thickness of 0.3 mm are respectively soldered on positive electrodes and negative electrodes. A high-capacity polymer lithium-ion battery of 500 Ah is obtained after packaging. The formed battery has a thickness of 13 mm, a width of 770 mm, and a length of 430 mm.

### Example 2

Small sheets are obtained through cutting for positive and negative electrode sheets. A separator diaphragm is not cut off. A folded structure as shown in FIG. 2 is used. Both surfaces of a negative electrode sheet are coated, and 30 negative electrode sheets are stacked. Both surfaces of a positive electrode sheet are coated, and 29 positive electrode sheets are stacked. For two outermost positive electrode sheets, only one surface is coated, to reduce material usage. After the electrode sheets are combined, aluminum tabs and copper tabs having a width of 280 mm and a thickness of 0.2 mm are respectively soldered on positive electrodes and negative electrodes. After packaging, a high-capacity polymer lithium-ion battery of 250 Ah is obtained. The formed battery has a thickness of 6.8 mm, a width of 770 mm, and a length of 430 mm.

For batteries in the foregoing two combination manners, an aluminum-plastic composite film is used for packaging. An aluminum strip or an aluminum-nickel composite strip is used for a base material of a lead end of a positive electrode of a battery, and a nickel strip or a copper strip is used for a base material of a negative tab. The size of an electrode sheet may depend on a coating capability of a manufacturer. By using the present utility model, the electrode sheets are small sheets that are easy to assemble, and a plane contact is provided between electrode sheets. An output tab of the battery may be flexibly designed according to the capacity of the battery. Therefore, production operations are facilitated, and the battery performance is stable and reliable, so that an optimal high-capacity battery structure is obtained.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A high-capacity polymer lithium-ion battery structure, comprising:
a positive electrode sheet, a separator diaphragm, a negative electrode sheet, another separator diaphragm, and another positive electrode sheet, which are sequentially stacked and thermally combined to form one battery unit,
wherein a plurality of battery units is connected in parallel,
tabs of the positive electrode sheets are connected in parallel and are then connected to a positive electrode of a battery housing,
tabs of the negative electrode sheet are connected in parallel and are then connected to a negative electrode of the battery housing, and
the tabs of the positive electrode sheets and the tabs of the negative electrode sheet are sealed in the battery housing.

2. The high-capacity polymer lithium-ion battery structure of claim 1, wherein the positive electrode sheets and the negative electrode sheets have increasing sizes in length and width directions.

3. The high-capacity polymer lithium-ion battery structure of claim 1, wherein the separator diaphragm is cut into single or continuously folded square sheets whose sizes are greater than those of the positive electrode sheets and the negative electrode sheets.

4. The high-capacity polymer lithium-ion battery structure of claim 1, wherein a battery cell capacity is between 50 Ah and 2000 Ah, a battery length is between 200 mm and 1000 mm, a battery width is between 200 mm and 1000 mm, and a battery thickness does not exceed 15 mm to 30 mm.

5. A high-capacity polymer lithium-ion battery structure, comprising:
a positive electrode sheet, a separator diaphragm continuously folded to wrap N negative electrode sheets, and another positive electrode sheet, which are combined to form a battery unit group stack structure,
wherein tabs of the two positive electrode sheets are connected in parallel and are then connected to a positive electrode of a battery housing, and
tabs of the N negative electrode sheets are connected in parallel and are then connected to a negative electrode of the battery housing.

6. The high-capacity polymer lithium-ion battery structure of claim 5, wherein N is between 2 and 35.

7. The high-capacity polymer lithium-ion battery structure of claim 5, wherein the positive electrode sheets and the negative electrode sheets have increasing sizes in length and width directions.

8. The high-capacity polymer lithium-ion battery structure of claim 5, wherein the separator diaphragm is cut into single or continuously folded square sheets whose sizes are greater than those of the positive electrode sheets and the negative electrode sheets.

9. The high-capacity polymer lithium-ion battery structure of claim 5, wherein a battery cell capacity is between 50 Ah and 2000 Ah, a battery length is between 200 mm and 1000 mm, a battery width is between 200 mm and 1000 mm, and a battery thickness does not exceed 15 mm to 30 mm.
